(19) United States
(12) Patent Application Publication
(10) Pub. No.: US 2026/0021585 A1
(43) Pub. Date: Jan. 22, 2026

(54) SIMULTANEOUS CALIBRATION OF EXTERNAL-FACING AND INTERNAL-FACING CAMERAS AND ILLUMINATION

(71) Applicant: Meta Platforms Technologies, LLC, Menlo Park, CA (US)

(72) Inventors: Luca Ricci, Zurich (CH); Bartolomeo Della Corte, Zurich (CH); Zoltán Pusztai, Zurich (CH); Michael Onyedika Umeano, Seattle, WA (US); Joern Rehder, Winterthur (CH); Jijie Xu, San Jose, CA (US); Francesco DeSantis, Zurich (CH)

(21) Appl. No.: 18/991,132

(22) Filed: Dec. 20, 2024

Related U.S. Application Data
(60) Provisional application No. 63/672,175, filed on Jul. 16, 2024.

(51) Int. Cl. H04N 17/00; B25J 9/16

(52) U.S. Cl. CPC H04N 17/002; B25J 9/1679

(57) ABSTRACT

A system of the subject technology includes a robotic arm including an end-effector configured to rigidly attach to a device, and several camera calibration targets positioned around the robotic arm. The system further includes a multifaceted calibration target consisting of an eye-tracking (ET) target and an ET illuminator target. The robotic arm is operable to rotate the device during a calibration process. The calibration process is a simultaneous calibration of cameras, inertial sensors and illuminators of the device.

### CROSS-REFERENCE TO RELATED APPLICATIONS

The present disclosure is related and claims priority under 35 USC § 119(e) to U.S. Provisional Application No. 63/672,175, entitled “SIMULTANEOUS CALIBRATION OF EXTERNAL-FACING AND INTERNAL-FACING CAMERAS AND ILLUMINATION,” filed on Jul. 16, 2024, the contents of which are herein incorporated by reference, in their entirety, for all purposes.

### TECHNICAL FIELD

The present disclosure generally relates to mixed reality (MR) devices, and more particularly, to a system and a methodology for simultaneous calibration of external-facing and internal-facing cameras and their illumination, applicable to augmented MR headsets.

### BACKGROUND

The use of cameras in MR headsets such as augmented reality (AR), virtual reality (VR) and extended reality (XR) cameras is pivotal to their functionality. These cameras capture real-world images and integrate them with virtual elements in MR, creating an immersive, interactive experience. In MR, cameras can be used for positional tracking, allowing the system to accurately render the user's perspective as the user moves within the virtual environment. Furthermore, cameras in these headsets can enable features like gesture recognition, object identification, and spatial mapping, enhancing the user's ability to interact with the virtual world. As technology advances, the role of cameras in MR headsets is expected to become even more integral, driving the development of more realistic and engaging experiences.

Various systems and methods have been used to calibrate cameras. For example, the use of flat targets for calibrating a camera is common practice in the computer-vision (CV) community. Spherical reflective targets have also been employed for calibration, for instance, in light-detection and ranging (LiDar) systems. Also, robots have been utilized in calibration of cameras and/or inertial measurement units (IMUs).

### SUMMARY

According to some aspects, a system of the subject technology includes a robotic arm including an end-effector configured to rigidly attach to a device, and several camera calibration targets positioned around the robotic arm. The system further includes a multifaceted calibration target consisting of an eye-tracking (ET) target and an ET illuminator target. The robotic arm is operable to rotate the device during a calibration process. The calibration process is a simultaneous calibration of cameras, inertial sensors and illuminators of the device.

According to other aspects, a method of the subject technology includes turning on illuminators of a device rigidly attached to an end-effector of a robotic arm, the device including cameras and inertial sensors. The method also includes causing the robotic arm to rotate the device around to allow scanning a multifaceted calibration target surrounding the robotic arm. The method further includes collecting data from the cameras and the inertial sensors, preprocessing the collected data, and running an algorithm to implement a simultaneous calibration of the cameras, the inertial sensors and the illuminators of the device using the preprocessed collected data.

According to yet other aspects, a calibration system of the subject technology includes a robotic arm operable to rotate a device during a calibration process, several camera calibration targets positioned around the robotic arm, and a multifaceted calibration target including an ET target and an ET illuminator target. The device is attached to the robotic arm and includes cameras, inertial sensors and illuminators to be simultaneously calibrated during the calibration process. The cameras include inward-facing cameras configured to support ET or face-tracking and outward-facing cameras configured to support a visual or a visual-inertial odometry system.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a headset for MR applications within which some aspects of the subject technology are implemented.

FIG. 2 is a schematic diagram illustrating an example of a system for calibration of a device, according to some aspects of the subject technology.

FIG. 3 is a schematic diagram illustrating an example of a camera calibration target with a calibration pattern, according to some aspects of the subject technology.

FIG. 4 is a schematic diagram illustrating an example of an ET illuminator target, according to some aspects of the subject technology.

FIG. 5 is a flow diagram illustrating an example of a method of simultaneous calibration of external-facing cameras, internal-facing cameras and their illumination, according to some aspects of the subject technology.

FIG. 6 is a flow diagram illustrating an example of an algorithm used in the calibration method of FIG. 5, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a system and a methodology for simultaneous calibration of external-facing and internal-facing cameras and their illumination. The disclosed techniques are applicable to MR (e.g., AR, VR and XR) devices. The subject technology obtains information regarding sensor location within the MR device efficiently by supporting simultaneous calibration of outward-facing cameras and inertial sensors, inward-facing cameras and an eye/face illuminator system. When virtual content is displayed in front of the eyes of a user wearing an MR headset or AR glasses, two types of information are used to make the experience realistic. 1) The position of the headset or smart glasses in the world (e.g., in an arbitrary, inertial coordinate system defined in space). This is typically obtained via a visual-inertial tracking system, that leverages outward-facing cameras and inertial sensors. 2) The position of the user's eyes with respect to the device itself (e.g., a coordinate system rigidly attached to the device). This information is provided by an eye-tracking system, typically based on inward looking cameras and an eye-illumination system such as infrared (IR) light-emitting diodes (LEDs).

Both the visual-inertial tracking and the eye-tracking systems have to use accurate knowledge of the location of the sensors in use of the device. For example, the visual-inertial tracking system has to know the relative positioning of cameras and IMUs as well as the mathematical models that compensate for deviation of the sensor from their ideal behavior (e.g., typical distortion of the image by a sensor such as a camera). Furthermore, the eye-tracking and the visual-inertial tracking systems have to be connected together to provide the required information such as the relative positioning of their sensor systems. The subject technology can efficiently obtain this information, as mentioned above, by supporting simultaneous calibration of outward-facing cameras and inertial sensors, inward-facing cameras and an eye and/or face illuminator system. Further, the disclosed method is also applicable to inward camera systems that do not directly observe the user, rather indirectly via means of optical reflection, e.g., via reflection off the display.

The subject technology is applicable to an MR device (headset) or smart glasses including one or more outward-facing cameras (e.g., to support a visual or a visual-inertial odometry system), one or more inward-facing cameras (e.g., to support eye or face tracking), one or more inward illumination systems (e.g., to support eye or face tracking) and one or more inertial sensors. The calibration system consists of a robotic arm with a mechanism to rigidly attach a device to its end-effector. A set of large camera calibration targets can be positioned around the robot (e.g., in a half cube layout), named the simultaneous localization and mapping (SLAM) targets. A multifaceted calibration target can consist of a) one or more faces with a camera calibration target that has known dimensions of its calibration pattern, referred to as the ET target; and b) one or more faces with a reflective, sphere shaped (with known radius) calibration target, referred to as the ET illuminator target.

The disclosed method consists of the following steps: 1) Turning on the inward camera illumination system. 2) Starting the data collection from all the cameras and inertial sensors at their respective sampling rate (e.g., about 30 Hz cameras and about 1 kHz IMU). 3) Moving the device around the multifaceted target such that: a) outward-facing cameras are observing the SLAM targets in most camera frames; b) the inward-facing cameras are observing the multifaceted target in most frames alternating between the ET target and the ET illuminator target, e.g., when inward cameras on one side are observing the ET target, the other side is observing the ET illuminator target and vice versa; c) rotations are fast enough to excite the inertial sensors' gyroscope; and d) the motion rotates the device and aligns each axis of an arbitrary coordinate system attached to the device to the gravity and anti-gravity direction. 4) Stopping the motion and the data collection. 5) Preprocessing the camera images with a feature matcher that extracts the correspondences between target fiducials and their projections on the image. 6) Running an algorithm that produces a calibration for all the sensors.

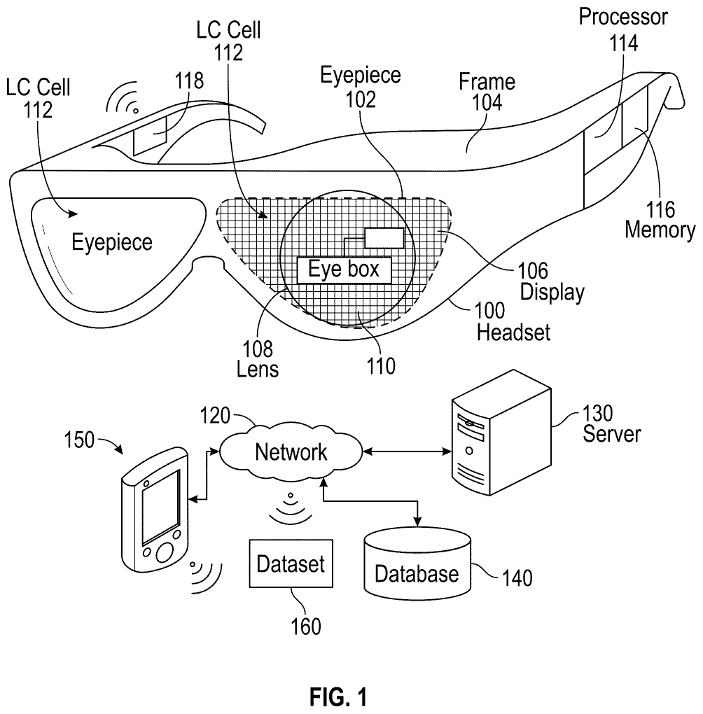

An example set of steps implemented by such an algorithm includes: a) initializing camera projection models from 3D/2D correspondences obtained from the preprocessing step; initializing camera trajectories via a PnP algorithm from 3D/2D correspondences and cameras projection models; b) defining a device continuous-time trajectory by computing the calibration target's relative positioning and the camera's relative positioning via a hand-eye algorithm; c) aligning the IMU trajectory by matching the sensed rotation and acceleration to the device trajectory (e.g., via numerical optimization); d) refining the IMU to the camera's relative positioning and computing the IMU model parameters (e.g., scale and bias terms) by solving a joint numerical optimization problem; and e) leveraging the inward camera projection model's knowledge and the device trajectory and the radius (this can alternatively be estimated as part of this algorithm) of the reflective sphere, estimating the position of the illuminator components with respect to the inward cameras. After completing the above-discussed steps 1-5 of the disclosed method, data from all of the calibrations are stored in the memory of the device (e.g., memory 116 of FIG. 1).

Calibration targets usually build around a single type of a priori known geometry (either planar, spherical, or other shapes). In contrast, the mirror ball target is two-sided: one side is spherical (mirror ball) and the other side is planar. The disclosed calibration target combines the benefits of the two worlds and enables multimodal calibration; that is, the simultaneous calibration of both cameras and illuminators. However, using mirror balls in MR devices introduces cross-reflections between the left and right sides. That is, the reflection of the illuminators on the left side are visible on the right side (from the right camera) as they are bounced back from the left (or right) mirror ball. To block these reflections, the disclosed target also introduces a separator item, which physically blocks these reflections.

Calibrating the cameras (with opposite view directions) and active illumination is achieved by using a special setup, which is faced with two challenges: 1) The cameras with no field-of-view (FOV) overlap require one or more calibration targets that cover the whole FOV. 2) In order to reflect the active illumination back to the cameras, reflective (also known as “mirror ball”) targets have to be used. The disclosed setup consists of a setup of three targets: a) for “outward” looking cameras, b) for the “inward” looking cameras and c) reflective targets for the active illumination. The carefully designed layout of the targets enables full coverage of FOV of all cameras (both forward and backward looking), while the reflective targets are used for illuminator calibration. The subject technology allows calibrating both direct and non-direct view ET cameras, SLAM cameras and ET illuminators on MR devices efficiently and cost effectively.

Turning now to the figures, FIG. 1 is a schematic diagram illustrating an example of a headset 100 for MR applications within which some aspects of the subject technology are implemented. The eyepieces 102 are mounted on a frame 104 and provide a transmitted image from the real world to a headset user. In some embodiments, a display 106 may also be configured to provide a computer-generated image to the headset user (e.g., for MR applications). The lens 108 optically couples the display 106 to an eye box 110 delimiting an area where a user's pupil is located.

At least one of the eyepieces 102 or the lens 108 includes an LC cell 112, as disclosed herein. Accordingly, the LC cell 112 may include a liquid crystal layer sandwiched between polymer aligning layers and electrode layers (not shown here for simplicity). The electrode layers provide an electric field that aligns the LC molecules in the LC layer along the electric field. The polymer alignment layer provides a default alignment of the LC molecules in the LC layer, absent an electric field across the electrode layer. When the electrodes are activated, the polymer alignment layer is oxidized (anode) and reduced (cathode), thus losing its ability to attach with LC molecules of the LC layer, which become free to align with the electric field. An LC layer may be used in one or both eyepieces 102 as a transparency controller. For example, the user may desire a high transparency in an area of an eyepiece that provides a real-world throughput image. When a portion of the eyepiece is used to display a computer-generated image or icon, it is desirable that the background of the eyepiece be opaque. In one or more implementations, the lens 108 coupling the display 106 or eyepiece 102 to the eye box 110 may include a pancake lens or other type of lens. In some implementations, the headset 100 includes a number of sensors and an IMU, not shown for simplicity.

The headset 100 may include a processor circuit 114 and a memory circuit 116. The memory circuit 116 may store instructions which, when executed by processor circuit 114, cause the headset 100 to provide the computer-generated image. In addition, the headset 100 may include a communications module 118. The communications module 118 may include radio-frequency software and hardware configured to wirelessly communicate with the processor circuit 114 and the memory circuit 116, with a network 120, a remote server 130, a database 140, or a mobile device 150 handled by the user of the headset 100. The headset 100, mobile device 150, remote server 130, and database 140 may exchange commands, instructions, and data, via a dataset 160, through the network 120. Accordingly, the communications module 118 may include radio antennas, transceivers, and sensors, and also digital processing circuits for signal processing according to any one of multiple wireless protocols such as Wi-Fi, Bluetooth, Near field contact (NFC), and the like.

In addition, the communications module 118 may also communicate with other input tools and accessories cooperating with the headset 100 (e.g., handle sticks, joysticks, mouse, wireless pointers, and the like). The network 120 may include, for example, any one or more of a local area network (LAN), a wide area network (WAN), the Internet, and the like. Further, the network 120 can include, but is not limited to, any one or more of the following network topologies, including a bus network, a star network, a ring network, a mesh network, a star-bus network, tree or hierarchical network, and the like.

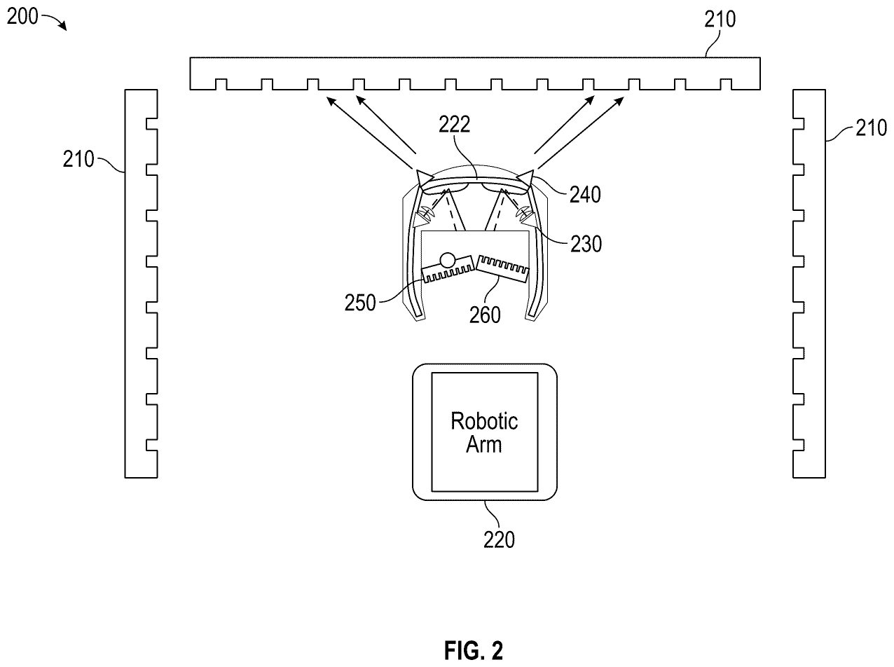

FIG. 2 is a schematic diagram illustrating an example of a system 200 for calibration of a device 202, according to some aspects of the subject technology. The device 202 can be a headset such as an MR headset or a smart eyeglass. The system 200 includes a robotic arm 210, several (e.g., three) camera calibration targets 220 (SLAM targets), inward-facing cameras 230 (ET cameras), outward-facing cameras 240 and multifaceted calibration targets 250, which include an ET target 252 and an ET illuminator target 254. In some implementations, the inward-facing cameras 230 and the outward-facing cameras 240 are mounted on the device 202. The robotic arm 210 includes a mechanism (e.g., an end-effector not shown in FIG. 2) to which the device 202 can be attached. The robotic arm 210 can be operated to move (e.g., rotate or translate) the device 202 around such that the outward-facing cameras 240 can observe the camera calibration targets 220 in most camera frames. The camera calibration targets 220 surround the device 202, enabling simultaneous coverage of all outward-facing cameras 240. The inward-facing cameras 230 can observe the multifaceted calibration targets 250 in most frames, alternating between the ET target 252 and the ET illuminator target 254. For example, when inward cameras on one side are observing the ET target 252, the other side is observing the ET illuminator target 254 and vice versa. The rotation of the robotic arm 210 is fast enough to excite the gyroscope of the inertial sensors (not shown for simplicity).

In FIG. 2, the camera calibration targets 220 are arranged in a half-cube configuration, but the subject technology is not limited to this arrangement and other suitable arrangements or configurations of the camera calibration targets 220 may be used. In some implementations, the inward-facing cameras 230 can be attached to the temples of the eyeglass, and the outward-facing cameras 240 can be mounted on the frame of the eyeglass as shown in FIG. 2. The inward-facing cameras 230 can look at the multifaceted calibration targets 250 similar to the way they look at the user's eyes during normal use. The inward-facing cameras 230 observe the multifaceted calibration targets 250 in most frames, alternating between the ET target 252 and the ET illuminator target 254, for example, when one of the inward-facing cameras 230 (on one side) is observing the ET target 252, the other one of the inward-facing camera 230 (on the other side) is observing the ET illuminator target 254, and vice versa.

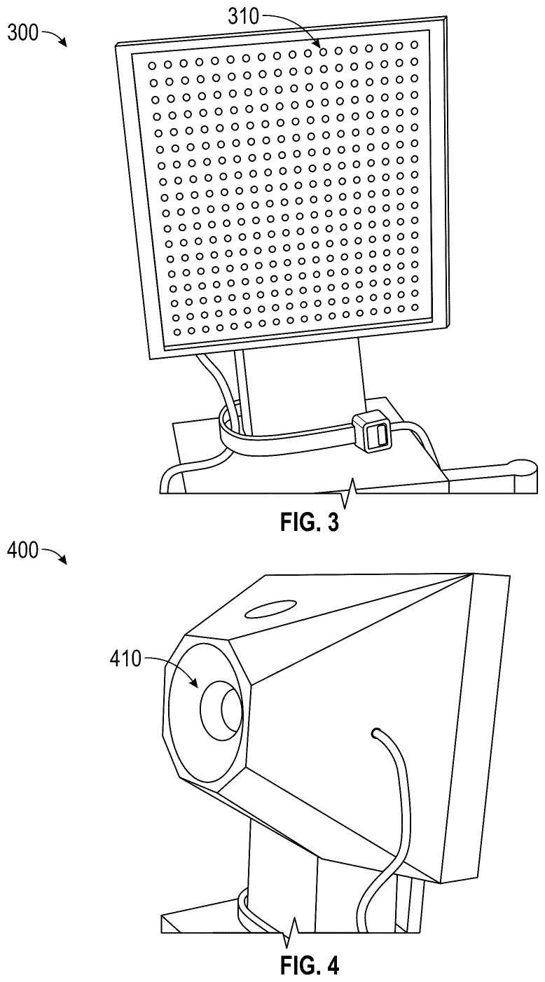

FIG. 3 is a schematic diagram illustrating an example of a camera calibration target 300 with a calibration pattern, according to some aspects of the subject technology. The camera calibration target 300 (also referred to as SLAM targets) includes a planar uniform light source (backlight, not visible in FIG. 3), which is covered with a dark sheet 310 including an array of patterned holes 320 with differing diameters. The disclosed calibration system (e.g., 200 of FIG. 2) includes a number of large camera calibration targets 300 (e.g., 220 of FIG. 2), which are positioned around the headset or eyeglass (e.g., 202 of FIG. 2) in a half-cube layout. The system also includes one or more faces similar to the camera calibration target 300 that has known dimensions of its calibration pattern referred to as the ET target (e.g., 252 of FIG. 2).

FIG. 4 is a schematic diagram illustrating an example of an ET illuminator target 400, according to some aspects of the subject technology. The ET illuminator target 400 is an implementation of the ET illuminator target 254 of FIG. 2. The ET illuminator target 400 includes one or more faces with a reflective and a sphere shaped, calibration target illuminator 410 with a known radius. The multifaceted calibration target 250 of FIG. 2 is being observed by the inward-facing cameras 230 of FIG. 2 in most frames. The inward-facing cameras 230 alternate between the ET target 252 of FIG. 2 and the ET illuminator target 400, that is, when one of the inward-facing cameras 230 on one side are observing the ET target 252, the other one of the inward-facing cameras 230 on the other side is observing the ET illuminator target 400 and vice versa.

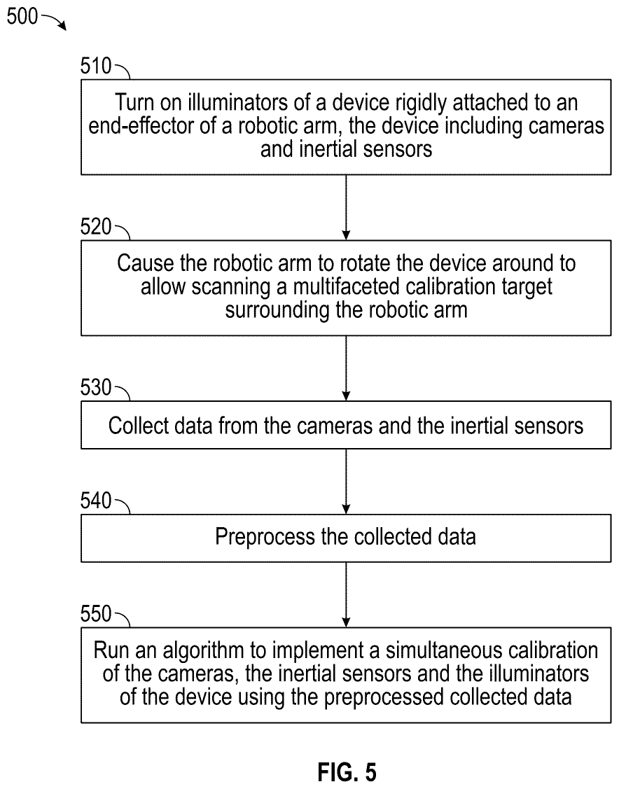

FIG. 5 is a flow diagram illustrating an example of a method 500 of simultaneous calibration of external-facing cameras (e.g., 240 of FIG. 2), internal-facing cameras (e.g., 230 of FIG. 2) and their illumination, according to some aspects of the subject technology. The method 500 includes process steps 510 through 550.

In process step 510, the illuminators (e.g., included in 254 of FIG. 2) of a device (202 of FIG. 2) rigidly attached to an end-effector of a robotic arm (210 of FIG. 2) are turned on, the device including cameras and inertial sensors.

In process step 520, the robotic arm rotates the device around to allow scanning a multifaceted calibration target (e.g., 220 of FIG. 2) surrounding the robotic arm.

In process step 530, the data from the cameras and the inertial sensors are collected.

In process step 540, the collected data are preprocessed. The preprocessing includes preprocessing of the camera images with a feature matcher that extracts the correspondences between target fiducials and their projections on the image.

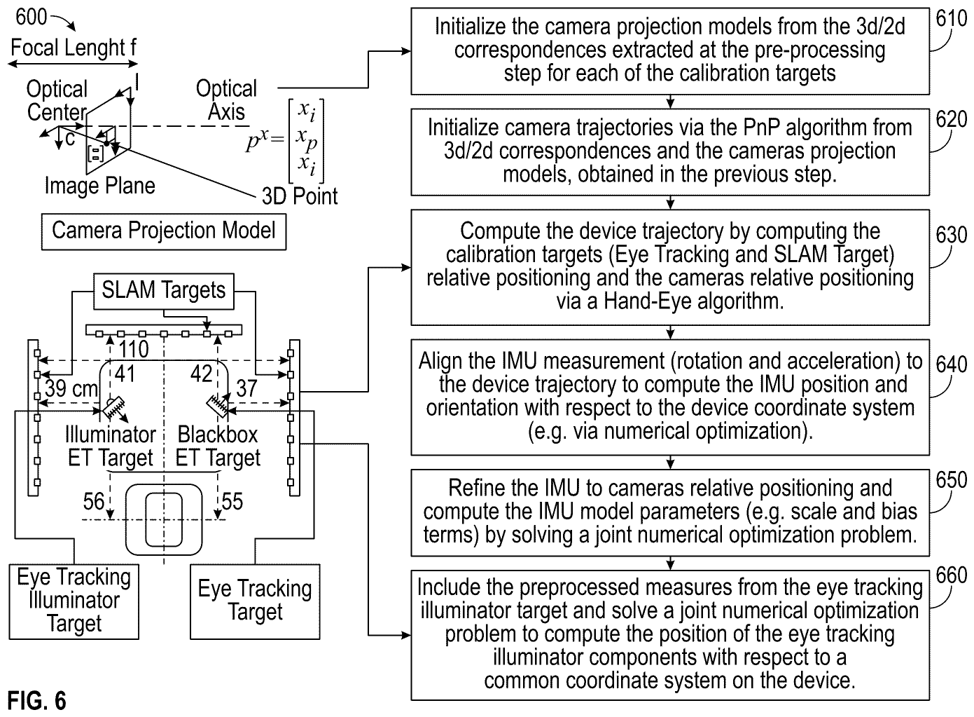

In step 550, an algorithm to implement a simultaneous calibration of the cameras, the inertial sensors and the illuminator of the device is executed using the preprocessed collected data. Finally, the entire calibration data is stored in a memory of the device (e.g., memory 116 of FIG. 1). Detail of the executed algorithm are given below with respect to FIG. 6.

FIG. 6 is a flow diagram illustrating an example of an algorithm 600 used in the calibration method of FIG. 5, according to some aspects of the subject technology. The algorithm 600 includes process steps 610 through 660.

In process step 610, the camera projection models (see 602) from the 3D/2D correspondences extracted at the preprocessing step 540 of FIG. 5 are initialized for each of the calibration targets.

In process step 620, the camera trajectories are initialized via a known perspective-n-point (PnP) algorithm from the 3D/2D correspondences and the cameras projection models, obtained in the previous step.

In process step 630, the device trajectory is determined by computing the calibration target's (eye tracking and SLAM target of 604) relative positioning and the camera's relative positioning via a known hand-eye algorithm used for robot calibration.

In process step 640, the IMU measurement (rotation and acceleration) is aligned to the device trajectory to compute the IMU position and orientation with respect to the device coordinate system (e.g., via numerical optimization).

In process step 650, the IMU is refined to camera's relative positioning and the IMU model parameters (e.g., scale and bias terms) are computed by solving a joint numerical optimization problem.

In process step 660, the preprocessed measures from the eye tracking illuminator target (see 604) are included and a joint numerical optimization problem is solved to compute the position of the eye tracking illuminator components with respect to a common coordinate system on the device.

An aspect of the subject technology is directed to a system including a robotic arm including an end-effector configured to rigidly attach to a device, and several camera calibration targets positioned around the robotic arm. The system further includes a multifaceted calibration target consisting of an ET target and an ET illuminator target. The robotic arm is operable to rotate the device during a calibration process. The calibration process is a simultaneous calibration of cameras, inertial sensors and illuminators of the device.

In some implementations, the device comprises a mixed reality device or a smart eyeglass.

In one or more implementations, the cameras comprise inward-facing cameras configured to support ET or face-tracking and outward-facing cameras configured to support a visual or a visual-inertial odometry system.

In some implementations, the robotic arm is configured to be operable to rotate the device to allow the outward-facing cameras to observe the camera calibration targets in most camera frames.

In one or more implementations, the robotic arm is configured to be operable to rotate the device to allow the inward-facing cameras to observe the multifaceted calibration target in most frames alternating between the ET target and the ET illuminator target.

In some implementations, a camera calibration target of the plurality of camera calibration targets comprises a dark sheet including patterned holes covering a uniform illuminator.

In one or more implementations, the plurality of camera calibration targets comprise SLAM targets positioned around the robotic arm in a half-cube layout.

In some implementations, the ET targets comprise one or more faces with a calibration target having calibration patterns with known dimensions.

In one or more implementations, the ET illuminator target comprises one or more faces with reflective, sphere-shaped calibration targets with known radii.

In some implementations, the robotic arm is configured to be operable to rotate the device sufficiently fast to excite a gyroscope of inertial sensors of the device and to allow alignment of each axis of an arbitrary coordinate-system attached to the device to gravity and anti-gravity directions.

Another aspect of the subject technology is directed to a method including turning on illuminators of a device rigidly attached to an end-effector of a robotic arm, the device including cameras and inertial sensors. The method also includes causing the robotic arm to rotate the device around to allow scanning a multifaceted calibration target surrounding the robotic arm. The method further includes collecting data from the cameras and the inertial sensors, preprocessing the collected data, and running an algorithm to implement a simultaneous calibration of the cameras, the inertial sensors and the illuminators of the device using the preprocessed collected data.

In some implementations, collecting the data from the cameras and the inertial sensors are performed at corresponding sampling rates.

In one or more implementations, the cameras include outward-facing cameras and inward-facing cameras, wherein scanning the multifaceted calibration target allows the outward-facing cameras to observe the multifaceted calibration target.

In some implementations, the multifaceted calibration target includes an ET target and an ET illuminator target, wherein scanning the multifaceted calibration target allows the inward-facing cameras to observe the multifaceted calibration target in most frames alternating between the ET target and the ET illuminator target.

In one or more implementations, the method further includes causing the robotic arm to rotate the device around to allow alignment of each axis of an arbitrary coordinate system attached to the device to gravity and anti-gravity directions and causing the robotic arm to rotate the device around sufficiently fast to excite a gyroscope of the inertial sensors of the device.

In some implementations, preprocessing the collected data comprises preprocessing camera images with a feature-matcher capable of extracting correspondences between target fiducials and target projections on the camera images.

In one or more implementations, the algorithm includes initializing camera projection models, defining a device continuous-time trajectory by computing a relative position of the multifaceted calibration target and relative positions of the cameras, aligning trajectory of the inertial sensors by matching sensed rotation and acceleration to a trajectory of the device, and leveraging knowledge of the camera projection model and the trajectory to estimate position of the illuminators with respect to inward-facing cameras.

Yet another aspect of the subject technology directed to a calibration system includes a robotic arm operable to rotate a device during a calibration process, several camera calibration targets positioned around the robotic arm, and a multifaceted calibration target including an ET target and an ET illuminator target. The device is attached to the robotic arm and includes cameras, inertial sensors and illuminators to be simultaneously calibrated during the calibration process. The cameras include inward-facing cameras configured to support ET or face-tracking and outward-facing cameras configured to support a visual or a visual-inertial odometry system.

In one or more implementations, the robotic arm is operable to rotate the device to allow the outward-facing cameras to observe the plurality of camera calibration targets in most camera frames, and to allow the inward-facing cameras to observe the multifaceted calibration target in most frames alternating between the ET target and the ET illuminator target.

In some implementations, the ET target comprises one or more first faces with a calibration target having calibration patterns with known dimensions, and the ET illuminator target comprises one or more second faces with reflective, sphere-shaped calibration targets with known radii.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause clement is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking (ET) system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system, comprising:
a robotic arm including an end-effector configured to rigidly attach to a device;
a plurality of camera calibration targets positioned around the robotic arm; and
a multifaceted calibration target including an eye-tracking (ET) target and an ET illuminator target,
wherein:
the robotic arm is configured to be operable to rotate the device during a calibration process, and
the calibration process comprises a simultaneous calibration of cameras, inertial sensors and illuminators of the device.

2. The system of claim 1, wherein the device comprises a mixed reality device or a smart eyeglass.

3. The system of claim 1, wherein the cameras comprise inward-facing cameras configured to support ET or face-tracking and outward-facing cameras configured to support a visual or a visual-inertial odometry system.

4. The system of claim 3, wherein the robotic arm is configured to be operable to rotate the device to allow the outward-facing cameras to observe the camera calibration targets in most camera frames.

5. The system of claim 3, wherein the robotic arm is configured to be operable to rotate the device to allow the inward-facing cameras to observe the multifaceted calibration target in most frames alternating between the ET target and the ET illuminator target.

6. The system of claim 1, wherein a camera calibration target of the plurality of camera calibration targets comprises a dark sheet including patterned holes covering a uniform illuminator.

7. The system of claim 1, wherein the plurality of camera calibration targets comprise simultaneous localization and mapping (SLAM) targets positioned around the robotic arm in a half-cube layout.

8. The system of claim 1, wherein the ET targets comprise one or more faces with a calibration target having calibration patterns with known dimensions.

9. The system of claim 1, wherein the ET illuminator target comprises one or more faces with reflective, sphere-shaped calibration targets with known radii.

10. The system of claim 1, wherein the robotic arm is configured to be operable to:
rotate the device sufficiently fast to excite a gyroscope of inertial sensors of the device; and
allow alignment of each axis of an arbitrary coordinate-system attached to the device to gravity and anti-gravity directions.

11. A method, comprising:
turning on illuminators of a device rigidly attached to an end-effector of a robotic arm, the device including cameras and inertial sensors;
causing the robotic arm to rotate the device around to allow scanning a multifaceted calibration target surrounding the robotic arm;
collecting data from the cameras and the inertial sensors;
preprocessing the collected data; and
running an algorithm to implement a simultaneous calibration of the cameras, the inertial sensors and the illuminators of the device using the preprocessed collected data.

12. The method of claim 11, wherein collecting the data from the cameras and the inertial sensors are performed at corresponding sampling rates.

13. The method of claim 11, wherein the cameras include outward-facing cameras and inward-facing cameras, wherein scanning the multifaceted calibration target allows the outward-facing cameras to observe the multifaceted calibration target.

14. The method of claim 13, wherein the multifaceted calibration target includes an ET target and an ET illuminator target, wherein scanning the multifaceted calibration target allows the inward-facing cameras to observe the multifaceted calibration target in most frames alternating between the ET target and the ET illuminator target.

15. The method of claim 11, further comprising:
causing the robotic arm to rotate the device around to allow alignment of each axis of an arbitrary coordinate system attached to the device to gravity and anti-gravity directions; and
causing the robotic arm to rotate the device around sufficiently fast to excite a gyroscope of the inertial sensors of the device.

16. The method of claim 11, wherein preprocessing the collected data comprises preprocessing camera images with a feature-matcher capable of extracting correspondences between target fiducials and target projections on the camera images.

17. The method of claim 11, wherein the algorithm comprises:
initializing camera projection models;
defining a device continuous-time trajectory by computing a relative position of the multifaceted calibration target and relative positions of the cameras;
aligning trajectory of the inertial sensors by matching sensed rotation and acceleration to a trajectory of the device; and
leveraging knowledge of the camera projection model and the trajectory to estimate position of the illuminators with respect to inward-facing cameras.

18. A calibration system, comprising:
a robotic arm operable to rotate a device during a calibration process;
a plurality of camera calibration targets positioned around the robotic arm; and
a multifaceted calibration target including an ET target and an ET illuminator target,
wherein:
the device is attached to the robotic arm and includes cameras, inertial sensors and illuminators to be simultaneously calibrated during the calibration process, and
the cameras comprise inward-facing cameras configured to support ET or face-tracking and outward-facing cameras configured to support a visual or a visual-inertial odometry system.

19. The calibration system of claim 18, wherein the robotic arm is configured to be operable to rotate the device to:
allow the outward-facing cameras to observe the plurality of camera calibration targets in most camera frames; and
allow the inward-facing cameras to observe the multifaceted calibration target in most frames alternating between the ET target and the ET illuminator target.

20. The calibration system of claim 18, wherein:
the ET target comprises one or more first faces with a calibration target having calibration patterns with known dimensions, and the ET illuminator target comprises one or more second faces with reflective, sphere-shaped calibration targets with known radii.
